(19) United States
(12) Patent Application Publication
(10) Pub. No.: US 2017/0140235 A1
(43) Pub. Date: May 18, 2017

(54) REMOTE CONTROL DEVICE BASED ON COMPUTER VISION TECHNOLOGY

(71) Applicant: Morpx Inc., Hangzhou (CN)

(72) Inventors: Tianli YU, Hangzhou (CN); Ming YANG, Hangzhou (CN); Gangqiang ZHAO, Hangzhou (CN); Yuping XU, Hangzhou (CN); Yang RAN, Hangzhou (CN)

(73) Assignee: Morpx, Inc., Hangzhou (CN)

(21) Appl. No.: 15/350,836

(22) Filed: Nov. 14, 2016

(30) Foreign Application Priority Data
Nov. 13, 2015 (CN) 201510782718.5

(51) Int. Cl. G06K 9/20; G08C 23/04; G06K 9/00

(52) U.S. Cl. CPC G06K 9/209; G06K 9/00335; G08C 23/04

(57) ABSTRACT

Provided is a remote control device based on computer vision technology, the remote control device includes a main body and a stand base connected with the main body. The main body includes a control unit, an output unit, a power supply unit, and a switch at least partially enclosed by a case. The control unit includes a visual sensor that collects image information and a microcontroller that outputs a control instruction to a controlled device via the output unit according to the image information collected by the visual sensor. The power supply unit is configured to supply power to the control unit and the output unit. The switch is configured to control the working state of the remote control device.

### CROSS-REFERENCE TO RELATED APPLICATION

This application is based upon and claims priority to Chinese Patent Application No. 201510782718.5, filed Nov. 13, 2015, the entire contents of which are incorporated herein by reference.

### TECHNICAL FIELD

The present disclosure relates to the field of remote control technology, and particularly to a remote control device based on computer vision technology.

### BACKGROUND

Computer vision technology can make a machine to acquire outside information via a camera just like human eyes, such that the machine can have the same perception ability like human vision, which can be more conducive to the intelligent development of the machine. However, in existing small interactive devices such as electric toys and robots, application of computer vision technology is not much. The reason is that the processing of visual information usually requires a lot of resources such as processors and memory. In addition, the power consumption is high, which can lead to high production costs and high use costs of small interactive devices. The traditional remote control device usually requires manual operation to achieve remote control on a controlled device and is unable to reach the stage of intelligent and unmanned control.

A remote control device without manual operation is desirable to address the issues.

### SUMMARY

In view of this, the present disclosure provides a remote control device based on computer vision technology, which can realize a remote control scheme without manual operation.

In a first aspect, a remote control device is provided based on computer vision technology. The remote control device includes a main body and a stand base connected with the main body; the main body includes a case and a control unit, an output unit, a power supply unit, and a switch at least partially enclosed by the case.

The control unit includes a visual sensor configured to collect image information and a microcontroller; the microcontroller is configured to output a set of control instructions to a controlled device via the output unit according to the image information collected by the visual sensor. The power supply unit is configured to supply power to the control unit and the output unit. The switch is configured to control the working state of the remote control device.

In a second aspect, the remote control device includes: a main body and a stand base connected with the main body; wherein the main body comprises a control unit, an output unit, a power supply unit, and a switch at least partially enclosed by a case. The control unit comprises a visual sensor configured to collect image information and a microcontroller; the microcontroller outputs a control instruction to a controlled device via the output unit according to the image information collected by the visual sensor. The stand base is configured to fix the remote control device to the controlled device. The switch is configured to control a working state of the remote control device.

It is to be understood that the above general description and the following detailed description are merely for the purpose of illustration and explanation, and are not intended to limit the scope of the protection of the disclosure.

### BRIEF DESCRIPTION OF THE DRAWINGS

FIG. 1 is a structure diagram illustrating a remote control device according to an embodiment of the present disclosure.

FIG. 2 is a structure developing diagram illustrating the remote control device according to the embodiment of the present disclosure.

FIG. 3 is a schematic flow chart illustrating the process of a microprocessor according to the embodiment of the present disclosure.

FIG. 4 is a control flow chart illustrating an infrared output mode according to an embodiment of the present disclosure.

FIG. 5 is a state transition diagram according to an alternative embodiment of the present disclosure.

FIG. 6 is a diagram illustrating a combination of a remote control device and a controlled device according to an embodiment of the present disclosure.

### DETAILED DESCRIPTION

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Technical schemes of the present disclosure will be described below with reference to the accompanying drawings. As can be seen, the present disclosure provides a remote control device based on computer vision technology. The remote control device includes a main body and a stand base connected with the main body. The main body includes a case and a control unit, an output unit, a power supply unit, and a switch at least partially enclosed by the case. The remote control device can transmit image information collected by a visual sensor arranged in the control unit to a microcontroller, which can in turn output a control instruction to a controlled device via the output unit according to the image information collected by the visual sensor. Therefore, the present disclosure can use computer vision technology instead of manual operation control so as to achieve real unmanned remote control, whereby the remote control device can transmit the control instruction as the eyes of the controlled device, and the controlled device can interact with the outside.

In order to solve the above problems, the present disclosure provides a remote control device based on computer vision technology, which includes a main body and a stand base connected with the main body. The main body includes a case and a control unit, an output unit, a power supply unit, and a switch at least partially enclosed by the case. The remote control device can transmit image information collected by a visual sensor arranged in the control unit to a microcontroller, which can in turn output a control instruction to a controlled device via the output unit according to the image information collected by the visual sensor. Therefore, the present disclosure can use computer vision technology instead of manual operation control so as to achieve real unmanned remote control, whereby the remote control device can transmit the control instruction as the eyes of the controlled device, and the controlled device can interact with the outside.

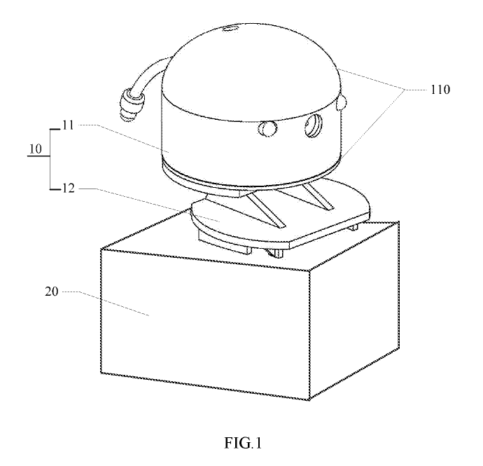

The present disclosure provides a remote control device based on computer vision technology, and FIG. 1 is a structure diagram illustrating the remote control device. As shown in FIG. 1, a remote control device 10 is configured to remote control a controlled device 20 and includes a main body 11 and a stand base 12 connected with the main body 11. The stand base 12 can be used to support the main body 11 and fix the main body 11 to the controlled device 20 according to demands.

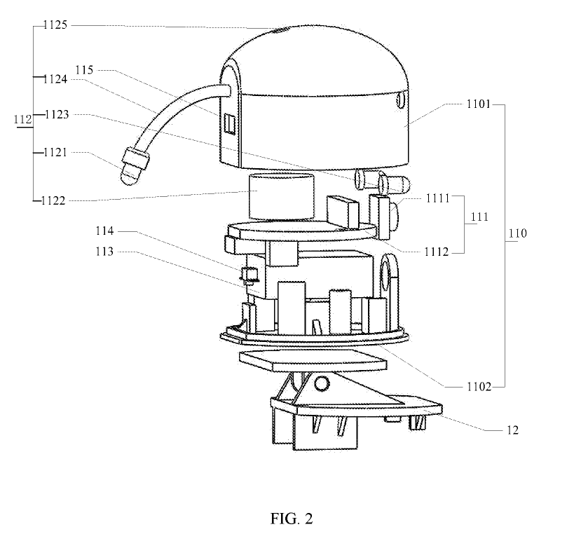

FIG. 2 is a structure diagram illustrating the remote control device according to the embodiment of the present disclosure. As shown in FIG. 2, the main body 11 includes a case 110. Generally, the case 110 can include an upper case 1101 and a lower case 1102; a control unit 111, an output unit 112, a power supply unit 113, and a switch 114 are enclosed between the upper case 1101 and the lower case 1102. The control unit 111 includes a visual sensor 1110 configured to collect image information and a microcontroller 1111; the microcontroller 1111 is configured to output the control instruction to the controlled device 20 via the output unit 112 according to the image information collected by the visual sensor. The power supply unit 113 is configured to supply power to the control unit 111 and the output unit 112. The switch 114 is configured to control the working state of the remote control device 10. Therefore, the present disclosure can use computer vision technology instead of manual operation control so as to achieve real unmanned remote control; the remote control device of the present disclosure has a good adaptability and can be applied to various scenarios.

As shown in FIG. 2, the visual sensor includes optical lens 1111 disposed on the surface of the upper case 1101 and sensor components connecting the microcontroller. In an alternative embodiment, the microcontroller and the sensor components of the visual sensor can be integrated onto a circuit board 1112 so as to save space.

Furthermore, the optical lens 1111 may include a complementary metal-oxide-semiconductor (CMOS) color camera, which includes a register configured to adjust the resolution of an image collected by the camera. In more detail, the visual sensor can use a CMOS color camera of VGA (640*480 pixels) resolution for image collection, formats of the image collected include but not limited to YUV format, RGB format and so on. Thereafter, the camera can reduce the resolution of the image collected to no more than 96*96 pixels, so as to avoid burden of image process caused by too large image pixels. The register can adjust the image resolution according to the adaption of the computational cost of image information required by different controlled devices and microcontrollers. Thus, the remote control device can be adapted to image collection of various image resolutions, which may include 96*72, 72*72, or other predetermined resolutions.

In addition, the microcontroller includes a memory and a flash memory, and both of them can be used to store the image information collected by the visual sensor, preset control algorithms used to analyze the image information, control signals to be output to the output unit, and other information. The microcontroller can recognize and extract information from the image information collected according to the preset control algorithms; the image information includes sphere, path, human body, human body distance, human face, gender, color, shape, and other information. The microcontroller can select different image recognition algorithms according to different purpose and invoke one or more image recognition algorithms over the same time so as to acquire recognition information from the image information. Thereafter, the recognition information acquired is processed via a preset control algorithm into a control instruction for controlling the controlled device 20. The control instruction can control the motion state of the controlled device 20, for example, the controlled device 20 can be controlled to forward, backward, turn left, turn right, stop, and complete other movements. Therefore, the present disclosure can use computer vision technology instead of manual operation control so as to achieve real unmanned remote control, whereby the remote control device can transmit the control instruction as the eyes of the controlled device, and the controlled device can interact with the outside.

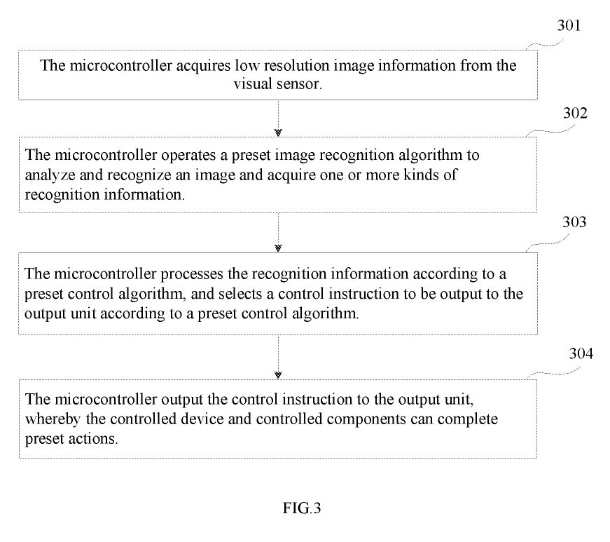

FIG. 3 is a schematic flow chart illustrating the process of a microprocessor according to the embodiment of the present disclosure. As shown in FIG. 3, the process includes the following steps.

Step 301, the microcontroller acquires information of an image with low resolution (hereinafter, can be referred to as low resolution image) from the visual sensor.

The image can be YUV format or RGB format and so on, and the resolution thereof is no more than 96*96 pixels.

Step 302, the microcontroller operates a preset image recognition algorithm so as to analyze and recognize the image and acquire one or more kinds of recognition information.

Generally, the recognition information can include but not limited to: sphere detection and recognition information, path detection and recognition information, human detection and recognition information, human head and shoulder detection and recognition information, face detection and recognition information, face gender detection and recognition information, color detection and recognition information, shape detection and recognition information, environment detection and recognition information, and so on.

The sphere detection and recognition information is configured to detect sphere information, such as location and size, from the low resolution image.

The path detection and recognition information is configured to detect path information, such as location and size, from the low resolution image.

The human detection and recognition information is configured to detect human head and shoulder information, such as location and size, from the low resolution image.

The human head and shoulder distance detection and recognition information is configured to further detect distance information between the human and intelligent hardware equipment after the human head and shoulder information is detected from the low resolution image.

The face detection and recognition information is configured to detect face information from the low resolution image.

The face gender detection and recognition information is configured to further detect face gender information on the basis of the face information detected from the low resolution image.

The color recognition information is configured to recognize color information from the low resolution image.

The shape detection and recognition information is configured to recognize characteristic shape information from the low resolution image.

The environment recognition information is configured to recognize environment information from the low resolution image.

Step 303, the microcontroller processes the recognition information according to a preset control algorithm, and selects a control instruction to be output to the output unit 112 according to the recognition information.

In an alternative embodiment of the present disclosure, the output unit 112 includes one or more infrared transmitters 1121. The infrared transmitter 1121 is configured to transmit the control instruction to the controlled device 20 via infrared signals. As one implementation, the infrared transmitter 1121 is configured to restrict the power of the infrared signals emitted by its own, whereby the infrared signals emitted by the infrared transmitter 1121 will only act on specified controlled devices 20. As shown in FIG. 2, the infrared transmitter 1121 connects with the upper case 1101 via a flexible pipe 1124; this allows the infrared transmitter 1121 to remain close to the controlled device 20, and the accuracy of remote control can be improved. If the controlled device 20 is not in direct contact with the current remote control device 10, multiple infrared transmitters 1121 can be arranged in various angles on the surface of the case 110 of the remote control device 10 in order to ensure that the control instruction can be transferred to the controlled device 20 smoothly, and the scope of control can be expanded.

Instead of the infrared transmitter 1121 of the remote control device 10, other signal transmission devices can be used so as to realize the control of different communication modes. The communication modes that can be compatible with the remote control device 10 may include at least one of: infrared communication, radio remote control communication, Bluetooth communication, WiFi communication, ZigBee communication, wired communication and so on. The remote control device 10 can use one or more communication modes described above simultaneously to realize control. Thus, the present disclosure is applicable to the control of a controlled device adopting various communication modes.

When adopting various communication modes, the remote control device 10 is able to define the range of signal control through a certain hardware technology, so as to avoid the interference of the control instruction to the non-target controlled device and to improve the communication quality and reliability. For example, in infrared communication, the infrared emission power can be reduced in terms of hardware, such as control the effective radius thereof in the range of 5 cm˜20 cm. In order to further enhance the anti interference performance, the infrared transmitter 1121 can use a lead out type infrared signal lamp on which a hood can be installed, thus, infrared light scattering can be prevented with the use of the hood, whereby achieve the effect of reducing interference. In radio remote control communication, the interference can be eliminated through band adjustment; at the same time, radio transmission power can be reduced to achieve the effect of reducing interference. Bluetooth communication, WiFi communication, or Zigbee communication can be distinguished via address codes in communication protocols, and transmission power can be reduced to achieve the effect of reducing interference.

The output of the control instruction will be illustrated by taking infrared transmission mode as an example.

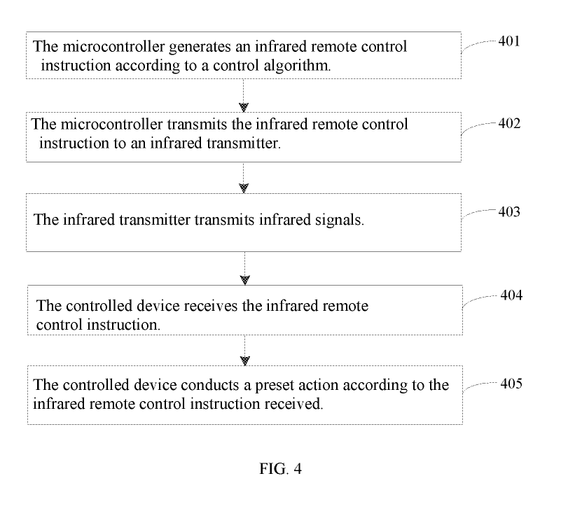

FIG. 4 is a control flow chart illustrating an infrared output mode according to an embodiment of the present disclosure. In infrared coding, modulation technology is adopted and square waves of 38 KHz are used as carrier signals; modulation signals ( 0, 1 coding) and infrared communication protocols can be selected according to different controlled devices. The microcontroller of the present disclosure is provided with a plurality of backup infrared communication protocols in the built-in flash memory. As shown in FIG. 4, the control process includes the following steps.

Step 401, the microcontroller generates an infrared remote control instruction according to a control algorithm.

Step 402, the microcontroller transmits the infrared remote control instruction to the infrared transmitter 1121.

Step 403, the infrared transmitter 1121 emits infrared signals.

Among which the infrared transmitter can use near infrared light to transmit an infrared remote control instruction, and the wavelength of the near infrared light is 0.76 um˜1.5 um.

Step 404, the controlled terminal 20 receives the infrared remote control instruction.

Step 405, the controlled terminal 20 conduct preset actions according to the infrared remote control instruction received.

During the working process of the controlled terminal, the above control process can continue for multiple times, whereby the controlled terminal can complete the preset actions continuously according to the control instruction transmitted.

In addition to the infrared transmitter configured to transmit the control instruction, the output unit 112 can further include a controlled components (for example, one or more audio devices 1122 or LED lamps 1123 ) configured to output a prompt message. In order to cooperate with the overall shape of the remote control device 10, the audio device 1122 can be arranged inside the case 110 and can emit a sound through an opening 1125 reserved on the upper case 1101. Wherein the audio device 1122 can include a buzzer, a speaker, and so on; and the LED lamp 1123 can be a LED lamp emitting color light and can be provided on the surface of the upper case 1101 in accordance with a preset design. With aid of the audio device 1122 or the LED lamp 1123, not only the prompt message such as a beeping or shining can be output, the design sense and interest of the product can be enhanced, thus the user can be provided with a new interactive experience.

Step 304, the microcontroller output the instruction to the output unit 112 such that the controlled device and the controlled components can complete preset actions.

Developers can pre-store alternative control instructions in the memory and the flash memory of the microcontroller. The control instructions can include moving direction information of the controlled device, moving speed information of the controlled device, switching information of the LED lamp, audio information played by the audio device, and the like.

Among them, the control instruction output to the controlled device by the microcontroller can be transmitted through infrared transmission or other transmission modes; the instruction output to the controlled component is transmitted through circuits.

The switch 114 is further configured to control the switching of algorithms that the microcontroller operates. So that schemes of image recognition and control instruction selection can be adjusted according to requirements of the user.

In an alternative embodiment of the present disclosure, the upper case 1101 has a USB interface 115 on the surface thereof. The USB interface 115 is configured to dock with a mobile phone or a computer. It is possible to update and replace control algorithms and image recognition algorithms built into the microcontroller, and to modify preset output information. In practice, by adjusting the control algorithms, the remote control device 10 can be controlled to generate different sounds and actions. The present disclosure can be used in conjunction with an application program. By connecting to a computer or a mobile phone via USB, the user can update a new action into the remote control device 10 of the present disclosure by utilizing the application program, and can autonomously edit sounds and actions. Therefore, playability can be increased and the individual needs of users can be met.

In an alternative embodiment of the present disclosure, the power supply unit 113 is a rechargeable lithium battery. And the USB interface 115 can further be used to charge the power supply unit 113 by connecting to a power source via a USB cable. Therefore, the remote control device 10 of the present disclosure is more convenient in charging, and the cost of replacing the battery is saved.

In an alternative embodiment of the invention, the lower surface of the main body 11, that is, the lower surface of the lower case 1102 of FIG. 2, and the upper surface of the stand base 12 can be connected in a preset connection configuration, the preset connection configuration can generally include but is not limited to, magnetic connection, adhesive bonding, snap connection, screw connection, and the like. The connection manner has the advantages of simple to operate, convenient loading and unloading, and the requirements on the operating capacity of the user are relatively low. Further, the stand base 12 can fix the remote control device 10 to the controlled device 20 and the radial angle of the stand base 12 can be varied so as to facilitate clamping, gluing, and other fixing manner designed with regard to different controlled devices 20.

In order to make the interactive mode provided by the present disclosure more clearly understood, the remote control mode of the present disclosure will be described in detail through a specific application example.

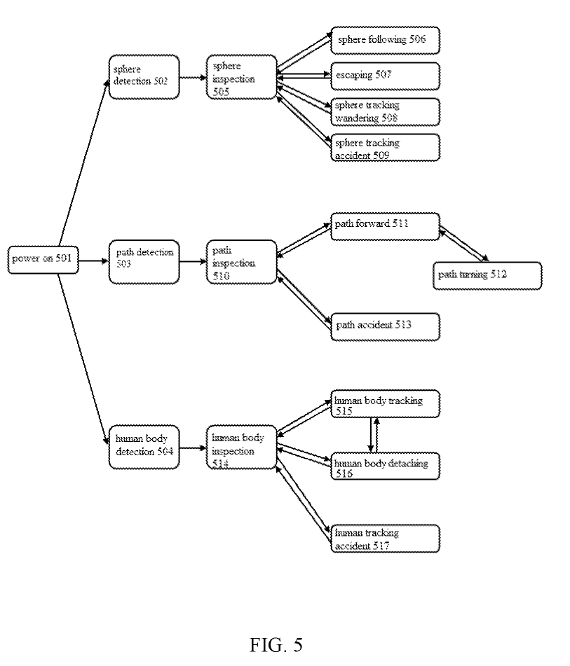

FIG. 5 is a state transition diagram according to an alternative embodiment of the present disclosure.

As shown in FIG. 5, the states include a power-on state 501, a sphere detection state 502, a path detection state 503, a human body detection state 504, a sphere inspection state 505, a sphere following state 506, an escaping state 507, a sphere tracking wandering state 508, a sphere tracking accident state 509, a path inspection state 510, a path forward state 511, a path turning state 512, a path error state 513, a human body inspection state 514, a human body tracking state 515, a human body detaching state 516, and a human tracking accident state 517.

In practical applications, in the power-on state 501, the user can manually select a following object of the controlled device so as to enter either of the sphere detection state 502, the path detection state 503, and the human body detection state 504.

The sphere inspection state 505 is entered when the user selects the sphere detection state 502.

In the sphere inspection state 505, the sphere following state 506 is triggered when the remote control device detects a sphere and the sphere is not red; the escaping state 507 is triggered if a sphere is detected and the sphere is not red; the sphere tracking wandering state 508 is triggered if no sphere is detected and the screen is not stationary; the sphere tracking accident state 509 is triggered if the screen is stationary. In the escaping state 507, the sphere tracking wandering state 508, and the sphere tracking accident state 509, return unconditionally to the sphere inspection state 505 after a corresponding state action is completed; in the sphere following state 506, jump to the sphere inspection state 505 after detecting the disappearance of the sphere inside the screen.

The path inspection state 510 is entered when the user selects the path detection state 503.

In the path inspection state 510, the path following state 511 is triggered when a path is detected by the remote control device, and the path turning state 512 is triggered when a turning path is detected in the path forward state 511; after the state action of the path turning state 512 is completed, return unconditionally to the path forward state 511; jump back to the path inspection state 510 if no path is detected in the path forward state 511. Further, in the path inspection state 510, the path error state 513 is triggered when the screen is stationary, return unconditionally to the path inspection state 510 after the state action of the path error state 513 is completed.

The human body inspection state 514 is entered when the user selects the human body detection state 504.

In the human body inspection state 514, the human body tracking state 515 is triggered when the remote control device recognizes a remote human body, and the human body detaching state 516 is triggered when a human body is recognized; in the human body tracking state 515, jump to the human body detaching state 516 if the human body distance recognized is less than a preset distance; in the human body detaching state 516, jump to the human body tracking state 515 if the human body distance recognized is greater than the preset distance; in the human body tracking state 515 and the human body detaching state 516, jump to the human body inspection state 514 if the human body in the screen is lost; in the human body inspection state 514, jump to the human tracking accident state 517 if the screen is stationary; and return unconditionally to the human body inspection state 514 after the preset action of the human tracking accident state 517 is completed.

In the above-described process, as to the sphere inspection state 505, the sphere following state 506, the escaping state 507, the sphere tracking wandering state 508, the sphere tracking accident state 509, the path inspection state 510, the path forward state 511, the path turning state 512, the path error state 513, the human body inspection state 514, the human body tracking state 515, the human body detaching state 516, the human tracking accident state 517, actions of the controlled device and the controlled components (Buzzer 1122, LED lamp 1123) in the output unit corresponding the states can be seen in Table 1.

TABLE 1

| State | Action |
|---|---|
| Sphere | Turn the head 360 degrees, make a “search” sound once, |
| inspection | eyes flash 2 times. |
| Sphere | Climb to the direction of the sphere, eyes continue to |
| following | light. |
| Escaping | Make a “fear” sound once, turn the body 180 degrees, |
| | and move forward 30 seconds, turn the head 180 |
| | degrees, and rapid eyes flash in the whole process. |
| Sphere tracking | Turn the head for a random angle, walk for a random |
| wandering | distance, and jump back to the sphere inspection. |
| Sphere tracking | Eyes rapid flash 4 times, move backward 3 seconds, |
| accident | jump back to the sphere inspection. |
| Path inspection | Walk for a random distance, turn the head (turn left and |
| | right 90 degrees respectively) to search a trajectory, |
| | eyes flash 2 times, change direction randomly and |
| | continue walking. |
| Path forward | Move along the trajectory, eyes continue to light. |
| Path turning | Stop and make a “doubt” sound once, eyes flash 2 times, |
| | then climb along a curved turn. |
| Path error | Eyes rapid flash 4 times, move backward 3 seconds, and |
| | jump back to the path inspection. |
| Human body | Walk for a random distance, turn the head (turn left and |
| inspection | right 150 degrees respectively) to search human body |
| | and make a “search” sound simultaneously, eyes flash 2 |
| | times, change direction randomly and continue walking. |
| Human | Continue to make a “forward” sound, climb to the |
| body | direction of the human body, eyes continue to light. |
| tracking | |
| Human body | Face the human body, climb backward, eyes continue to |
| detaching | light. |
| Human | Eyes rapid flash 4 times, move backward 4 times, jump |
| tracking | back to the human body inspection. |
| accident | |

Each of the sounds of “search”, “fear”, “doubt”, and “forward” is made by the audio device 1122 in accordance with a preset mode; “flash” of the eyes is performed by two LED lamps 1123, for example, each flashing of a lamp indicates that the eyes flash once.

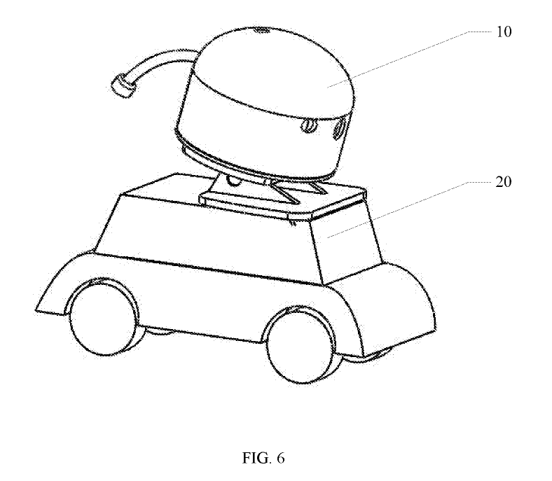

FIG. 6 is a diagram illustrating a combination of the remote control device and the controlled device according to an embodiment of the present disclosure. Refer to FIG. 6, suppose the remote control device 10 is installed on the controlled device 20. The controlled device 20 is a toy car. With the above-described operation, the remote control device 10 and the toy car 20 of the present disclosure can be combined to exhibit the following characteristics:

when the remote control device 10 detects a sphere which is not red, the toy car 20 follow the sphere for movement, and when a red sphere is detected, the toy car 20 turns to run away;

when the remote control device 10 detects a path, the toy car 20 follows the path for movement, and when the path turns and bifurcates, the toy car 20 selects a subsequent path autonomously and randomly;

when the human body is detected by the remote control device 10, the toy car 20 follows the human body for movement, and when the human body is too close, the toy car 20 retreats away;

when no object is detected by the remote control device 10, the toy car 20 searches for an object to be detected autonomously and randomly; and

when the remote control device 10 encounters an obstacle during movement and is forced to stop the movement, the toy car 20 retreats to away from and avoid the obstacle.

In addition, the remote control device 10 can also use the LED lamp and sound to express the mood of search, pleasure, and shock in the process.

Therefore, the present disclosure uses the computer vision technology instead of the manual control operation to realize the real unmanned remote control, whereby the remote control device can transmit the control instruction as the eyes of the controlled toy, and the original controlled toy can interact with the outside and increase the function of the toy. The remote control device can enhance function of the other device so that it becomes more intelligent and interesting.

The descriptions above are only the preferable embodiment of the present disclosure, which are not used to restrict the present disclosure. For those skilled in the art, the present disclosure may have various changes and variations. Any amendments, equivalent substitutions, improvements, etc, within the principle of the present disclosure are all included in the scope of protection of the present disclosure.

What is claimed is:

1. A remote control device, comprising:
a main body and a stand base connected with the main body; wherein the main body comprises a control unit, an output unit, a power supply unit, and a switch at least partially enclosed by a case;
the control unit comprises a visual sensor configured to collect image information and a microcontroller; the microcontroller outputs a control instruction to a controlled device via the output unit according to the image information collected by the visual sensor;
the power supply unit is configured to supply power to the control unit and the output unit; and
the switch is configured to control a working state of the remote control device.

2. The remote control device of claim 1, wherein the visual sensor comprises optical lens disposed on a surface of the case and sensor components connected to the microcontroller.

3. The remote control device of claim 2, wherein the optical lens comprises a complementary metal-oxide-semiconductor (CMOS) color camera, the camera comprises a register inside, and the register is configured to adjust a resolution of an image collected by the camera.

4. The remote control device of claim 1, wherein the microcontroller comprises a memory and a flash memory; the memory and the flash memory are configured to store the image information collected by the visual sensor, preset algorithms, and the control instruction output to the output unit.

5. The remote control device of claim 1, the microcontroller outputs the control instruction to the controlled device via the output unit according to the image information collected by the visual sensor comprises:
the microcontroller recognizes and extracts recognition information from the image collected according to a preset image recognition algorithm, and process the recognition information into the control instruction controlling the controlled device through a preset control algorithm.

6. The remote control device of claim 5, wherein the switch is further configured to control the switching of control algorithms operated by the microcontroller.

7. The remote control device of claim 1, wherein the output unit outputs the control instruction using at least one of the following: wireless radio transmission, infrared transmission, Bluetooth transmission, WiFi transmission, ZigBee transmission, and cable transmission.

8. The remote control device of claim 1, wherein the output unit comprises one or more infrared transmitters configured to transmit the control instruction to the controlled device via infrared signals.

9. The remote control device of claim 8, wherein the infrared transmitters and the case are connected via a flexible pipe.

10. The remote control device of claim 1, wherein the output unit further comprises one or more audio devices.

11. The remote control device of claim 1, wherein the output unit further comprises one or more LED lamps disposed on a surface of the case.

12. The remote control device of claim 1, further comprising an interface that is configured to dock with a mobile phone or a computer and connect to a power supply through a cable so as to charge the power supply unit.

13. The remote control device of claim 1, wherein the power supply unit comprises a lithium battery.

14. The remote control device of claim 1, wherein a lower surface of the main body and an upper surface of the stand base are connected via a preset connection manner.

15. The remote control device of claim 1, wherein the stand base is configured to fix the remote control device to the controlled device, and the stand base has a variable radial angle.

16. A remote control device, comprising:
a main body and a stand base connected with the main body; wherein the main body comprises a control unit, an output unit, a power supply unit, and a switch at least partially enclosed by a case;
wherein the control unit comprises a visual sensor configured to collect image information and a microcontroller; the microcontroller outputs a control instruction to a controlled device via the output unit according to the image information collected by the visual sensor;
wherein the stand base is configured to fix the remote control device to the controlled device; and
wherein the switch is configured to control a working state of the remote control device.
